(19) United States
(12) Patent Application Publication
(10) Pub. No.: US 2026/0272243 A1
(43) Pub. Date: Sep. 17, 2026

(54) Cleaning Robot Cleaning Method and System

(71) Applicant: Anker Innovations Technology Co., Ltd., Changsha (CN)

(72) Inventors: Yuanchao Luo, Shenzhen (CN); Zuguo Yu, Shenzhen (CN)

(21) Appl. No.: 19/675,752

(22) Filed: May 13, 2026

Related U.S. Application Data
(63) Continuation of application No. PCT/CN2024/126414, filed on Oct. 22, 2024.

(30) Foreign Application Priority Data
Nov. 15, 2023 (CN) 202311525008.5

(51) Int. Cl. A47L 11/40; F26B 25/22

(52) U.S. Cl. CPC A47L 11/4011; A47L 11/4091; F26B 25/22; A47L 2201/028

(57) ABSTRACT

This application relates to a mop cleaning method and a cleaning system. The method comprises: determining a task status of a mop cleaning task of a cleaning robot; and determining that the task status changes from an unexecutable state to an executable state. The method also comprises in response to determining that the task status changes from the unexecutable state to the executable state, controlling, based on a mop status of the cleaning robot, the cleaning robot to perform mop cleaning. The mop cleaning includes at least one of mop washing and mop drying.

### CROSS-REFERENCE TO RELATED APPLICATIONS

This application claims priority to PCT/CN2024/126414, filed on October 22, 2024, which claims priority to Chinese Patent Application No. 2023115250085, entitled “MOP CLEANING METHOD AND CLEANING SYSTEM” and filed on November 15, 2023, each of which is incorporated herein by reference in its entirety.

### TECHNICAL FIELD

This application relates to the field of smart home device technologies, and in particular, to a mop cleaning method and a cleaning system.

### BACKGROUND

With the development of smart home device technologies, cleaning robots have emerged. The cleaning robots can automatically perform household tasks such as sweeping and mopping.

In the related art, a user usually issues a mopping instruction through a terminal. After receiving the mopping instruction, a cleaning robot automatically performs mopping in a room. After completing the mopping, the cleaning robot returns to a base station and performs mop cleaning at the base station.

However, if the cleaning robot is in a state in which the cleaning robot cannot execute a mop cleaning task due to external reasons, for example, if the cleaning robot is disconnected from the base station, or if the cleaning robot enters a do-not-disturb mode, after the status of the cleaning robot changes to mop cleaning task-executable state, the user needs to manually issue an instruction to control the cleaning robot to re-execute the mop cleaning task. Only in this way can the cleaning robot resume mop cleaning. Consequently, user convenience is degraded when the cleaning robot performs mop cleaning.

### SUMMARY

To address the foregoing technical problems, it is advantageous to provide a cleaning method and a cleaning system for a cleaning robot that can improve user convenience when the cleaning robot performs mop cleaning.

According to a first aspect, this application provides a mop cleaning method. The method comprises: determining a task status of a mop cleaning task of the cleaning robot; and determining that the task status changes from an unexecutable state to an executable state. The method also comprises in response to determining that the task status changes from the unexecutable state to the executable state, controlling, based on a mop status of the cleaning robot, the cleaning robot to perform mop cleaning. The mop cleaning includes at least one of mop washing and mop drying.

In one of the examples, the controlling, based on a mop status of the cleaning robot, the cleaning robot to perform mop cleaning comprises: controlling, if the mop status is a to-be-washed state or a washing-uncompleted state, the cleaning robot to perform mop washing and full mop drying; controlling, if the mop status is a washed but not-being-dried state, the cleaning robot to perform full mop drying; and controlling, if the mop status is a washed but drying-uncompleted state, according to time information associated with the mop cleaning task, the cleaning robot to perform mop cleaning.

In one of the examples, the time information includes a duration of the cleaning robot being in the unexecutable state. The controlling, according to time information associated with the mop cleaning task, the cleaning robot to perform mop cleaning comprises: controlling, if the duration is greater than a preset duration, the cleaning robot to perform mop washing and full mop drying; and controlling, if the duration is less than or equal to the preset duration, the cleaning robot to perform supplementary mop drying.

In one of the examples, the time information includes a duration of the cleaning robot being in the unexecutable state and an elapsed drying duration of a mop; and the controlling, according to time information associated with the mop cleaning task, the cleaning robot to perform mop cleaning comprises: determining, according to the duration and the elapsed drying duration of the mop, whether mop re-washing needs to be performed; controlling, if mop re-washing needs to be performed, the cleaning robot to perform mop washing and full mop drying; and controlling, if mop re-washing does not need to be performed, the cleaning robot to perform supplementary mop drying.

In one of the examples, the determining, according to the duration and the elapsed drying duration of the mop, whether mop re-washing needs to be performed, comprises: generating a first evaluation value according to the duration and the elapsed drying duration, where the first evaluation value is used for evaluating an odor level of the mop after the task status changes from the unexecutable state to the executable state; determining, if the first evaluation value is greater than a preset evaluation value, that mop re-washing needs to be performed; and determining, if the first evaluation value is less than or equal to the preset evaluation value, that mop re-washing does not need to be performed.

In one of the examples, the method further comprises: controlling, if an interval duration between a current time point and a start time point of the cleaning robot being in the unexecutable state is greater than a preset interval duration, the cleaning robot to perform mop cleaning; and prohibiting, if the interval duration is less than or equal to the preset interval duration, the cleaning robot from performing mop cleaning.

In one of the examples, a mop of the cleaning robot includes a plurality of to-be-dried mop regions, and the time information includes a duration of the cleaning robot being in the unexecutable state and elapsed region drying durations of the to-be-dried mop regions; and the controlling, according to time information associated with the mop cleaning task, the cleaning robot to perform mop cleaning comprises: determining, according to the duration and the elapsed region drying durations of the to-be-dried mop regions, whether mop re-washing needs to be performed; and controlling, if mop re-washing needs to be performed, the cleaning robot to perform mop washing and full mop drying; and controlling, if mop re-washing does not need to be performed, the cleaning robot to perform supplementary mop drying.

In one of the examples, the determining, according to the duration and the elapsed region drying durations of the to-be-dried mop regions, whether mop re-washing needs to be performed includes: respectively generating, according to the duration and the elapsed region drying durations, second evaluation values corresponding to the to-be-dried mop regions, wherein the second evaluation value is used for evaluating an odor level of the to-be-dried mop region after the task status changes from the unexecutable state to the executable state; determining, if a maximum value in the second evaluation values is greater than a preset evaluation value, that mop re-washing needs to be performed; and determining, if the maximum value in the second evaluation values is less than or equal to the preset evaluation value, that the mop re-washing does not need to be performed.

In one of the examples, before the determining, according to the duration and the elapsed region drying durations of the to-be-dried mop regions, whether mop re-washing needs to be performed, the method further comprises: obtaining a number of completed rotations of the mop in a drying process; and determining the elapsed region drying durations of the to-be-dried mop regions according to the number of completed rotations and a total elapsed drying duration of the mop.

In one of the examples, the method further comprises: setting the task status of the mop cleaning task to the unexecutable state if a current time point falls within a preset do-not-disturb time period; and setting the task status of the mop cleaning task to the executable state if the current time point does not fall within the preset do-not-disturb time period.

In one of the examples, the method further comprises: setting the task status of the mop cleaning task to the unexecutable state if the cleaning robot is disconnected from a base station; and setting the task status of the mop cleaning task to the executable state if the cleaning robot is connected to the base station.

According to a second aspect, this application further provides a mop cleaning apparatus. The apparatus includes: a task status determining module, configured to determine a task status corresponding to a mop cleaning task of the cleaning robot; and a mop cleaning module, configured to determine that the task status changes from an unexecutable state to an executable state; and in response to determining that the task status changes from the unexecutable state to the executable state, control, based on a mop status of the cleaning robot, the cleaning robot to perform mop cleaning. The mop cleaning includes at least one of mop washing and mop drying.

According to a third aspect, this application further provides a cleaning system, including a cleaning robot and a base station. The cleaning robot includes a body and a mop arranged on the body. The base station includes a washing sink configured for washing the mop and a drying module configured to dry the mop. The cleaning robot includes a memory and a processor. The memory has a computer program stored therein. The processor, when executing the computer program, can implement the following steps: determining a task status corresponding to a mop cleaning task of the cleaning robot; determining that the task status changes from an unexecutable state to an executable state; and in response to determining that the task status changes from the unexecutable state to the executable state, controlling, based on a mop status of the cleaning robot, the cleaning robot to perform mop cleaning. The mop cleaning includes at least one of mop washing and mop drying.

According to a fourth aspect, this application further provides a non-transitory computer-readable storage medium. The computer-readable storage medium has a computer program stored therein. The computer program, when executed by a processor, implements the following steps: determining a task status of a mop cleaning task of the cleaning robot; determining that the task status changes from an unexecutable state to an executable state; and in response to determining that the task status changes from the unexecutable state to the executable state, controlling, based on a mop status of the cleaning robot, the cleaning robot to perform mop cleaning. The mop cleaning includes at least one of mop washing and mop drying.

According to a fifth aspect, this application further provides a computer program product. The computer program product includes a computer program. The computer program, when executed by a processor, implements the following steps: determining a task status of a mop cleaning task of the cleaning robot; determining that the task status changes from an unexecutable state to an executable state; and in response to determining that the task status changes from the unexecutable state to the executable state, controlling, based on a mop status of the cleaning robot, the cleaning robot to perform mop cleaning. The mop cleaning includes at least one of mop washing and mop drying.

According to the foregoing mop cleaning method and cleaning system, the task status corresponding to the mop cleaning task of the cleaning robot can be determined, and when the task status changes from the unexecutable state to the executable state, the cleaning robot is triggered to automatically perform the mop cleaning step. The method comprises controlling, according to the mop status of the cleaning robot, the cleaning robot to perform mop cleaning. The mop cleaning includes at least one of mop washing and mop drying. In this way, even if the cleaning robot is in the mop cleaning task-unexecutable state (e.g., the cleaning robot is in a do-not-disturb time period), the cleaning robot can still automatically perform mop cleaning according to the mop status of the cleaning robot without requiring a user to manually issue an instruction to control the cleaning robot to resume mop cleaning. Therefore, user convenience can be improved when the cleaning robot performs mop cleaning.

### BRIEF DESCRIPTION OF THE DRAWINGS

To describe the technical solutions in the application or the related art more clearly, the following briefly describes the accompanying drawings required for describing the examples or the related art. Apparently, the accompanying drawings in the following description show merely examples of this application, and a person of ordinary skill in the art may still derive other drawings from the disclosed accompanying drawings without creative efforts.

FIG. 1 is a schematic flowchart of a mop cleaning method according to an example;

FIG. 2 is a schematic flowchart of performing mop drying by a cleaning robot according to an example;

FIG. 3 is a schematic flowchart of performing mop drying by a cleaning robot on a mop according to still another embodiment;

FIG. 4 is a structural block diagram of a mop cleaning apparatus according to an example; and

FIG. 5 is a diagram of an internal structure of a cleaning robot according to an example.

### DETAILED DESCRIPTION

The following clearly and completely describes the technical solutions in this application with reference to the accompanying drawings in this application. Apparently, the described examples are merely some rather than all of the examples of this application. All other examples obtained by a person of ordinary skill in the art based on examples of this application without creative efforts shall fall within the protection scope of this application.

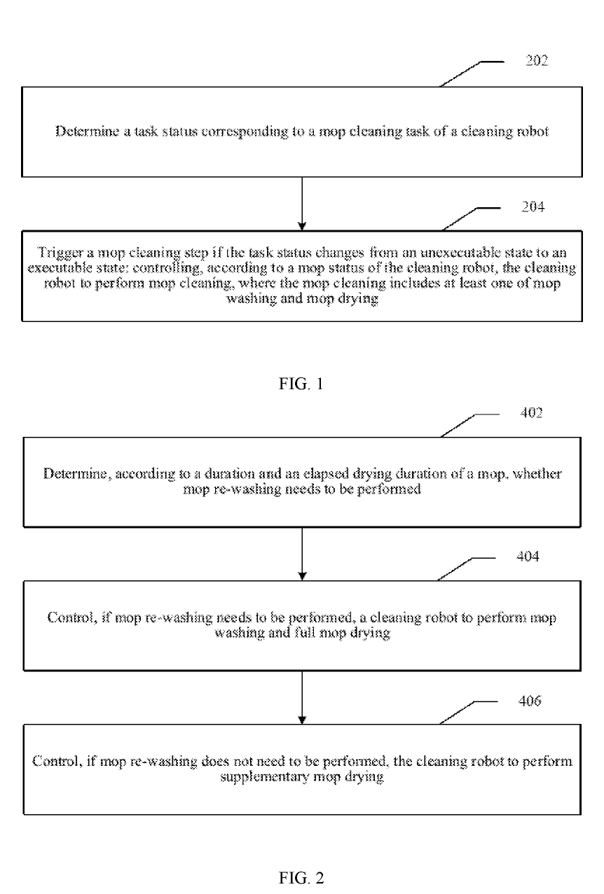

In an example, as shown in FIG. 1, a mop cleaning method is provided, which is described by using an example in which the method is applied to a cleaning robot, and includes the following steps:

Step 202: Determine a task status corresponding to a mop cleaning task of the cleaning robot.

The cleaning robot may be a sweeper, a mopper, an automatic floor scrubber, or the like. After the cleaning robot completes a sweeping or mopping task, a mop of the cleaning robot is in a dirty state, and the cleaning robot returns to a base station to execute a mop cleaning task. The mop cleaning task by the cleaning robot includes two processes: mop washing and mop drying. Usually, a duration taken for mop washing is shorter, and a duration taken for mop drying is longer.

In an example, the task status may be an executable state and an unexecutable state. The executable state represents that the cleaning robot can currently execute a mop cleaning task, and the unexecutable state represents that the cleaning robot cannot currently execute a mop cleaning task.

In an example, when the task status of the cleaning robot is the unexecutable state, a "Button" of a mop cleaning mode of the cleaning robot may be displayed in gray (with low brightness), to represent that the cleaning robot cannot currently execute a mop cleaning task. When the task status of the cleaning robot is the executable state, the "Button" of the mop cleaning mode of the cleaning robot may be displayed in a normal screen color (with high brightness), to represent that the cleaning robot can currently execute a mop cleaning task.

In an example, if a current time point falls within a preset do-not-disturb time period, it indicates that the task status of the mop cleaning task is the unexecutable state. If the current time point does not fall within the preset do-not-disturb time period, it indicates that the task status of the mop cleaning task is the executable state.

In an example, if the cleaning robot is disconnected from a base station, it indicates that the task status of the mop cleaning task is the unexecutable state. If the cleaning robot is connected to the base station, it indicates that the task status of the mop cleaning task is the executable state.

Step 204: Trigger a mop cleaning step if the task status changes from an unexecutable state to an executable state: controlling, according to a mop status of the cleaning robot, the cleaning robot to perform mop cleaning, where the mop cleaning includes at least one of mop washing and mop drying.

The mop status is a status representing a degree to which a mop has been cleaned. For example, the mop status may be a to-be-washed state, a washing-uncompleted state, a washed but not-being-dried state, a drying-uncompleted state, and the like.

In an example, step 204 includes: determining the mop status of the cleaning robot according to a previous cleaning mode of the cleaning robot if the task status changes from the unexecutable state to the executable state, where, for example, if the previous cleaning mode is a mop washing mode, it can be determined that the mop status is a washing-uncompleted state; and if the previous cleaning mode is that a mop drying mode has not started, but the mop washing mode has ended, it can be determined that the mop status is a washed but not-being-dried state; and determining a current cleaning mode of the cleaning robot according to the mop status, and controlling, in the current cleaning mode, the cleaning robot to perform mop cleaning, where the mop cleaning includes at least one of mop washing and mop drying.

In an example, the current cleaning mode may be a re-washing mode or a supplementary drying mode. Re-washing refers to washing the mop again and performing full drying. Full drying refers to performing a complete drying process on the mop. Supplementary drying refers to resuming drying on the mop based on an elapsed drying duration of the mop. A duration of supplementary drying may be a drying duration determined according to a difference between a preset full drying duration and an elapsed drying duration. For example, full drying may be a process of continuously drying the mop for three hours, and supplementary drying may be a process of continuously drying the mop for less than three hours.

In an example, the controlling, according to a mop status of the cleaning robot, the cleaning robot to perform mop cleaning includes:

controlling, if the mop status is a to-be-washed state or a washing-uncompleted state, the cleaning robot to perform mop washing and full mop drying; and controlling, if the mop status is a washed but drying-uncompleted state, according to time information associated with the mop cleaning task, the cleaning robot to perform mop cleaning.

Specifically, if the mop status is a to-be-washed state or a washing-uncompleted state, the cleaning robot is controlled to perform mop washing, and the cleaning robot is controlled to perform full mop drying after the washing is completed. If the mop status is a washed but drying-uncompleted state, the cleaning robot is controlled, according to time information associated with the mop cleaning task, to perform mop cleaning. The mop cleaning includes at least one of mop washing and mop drying.

In an example, the washed but drying-uncompleted state may be a state in which drying is not performed after washing is completed, or may be a state in which drying is performed after washing is completed, but drying is not completed.

In an example, the time information includes an elapsed drying duration of the mop, and the controlling, according to time information associated with the mop cleaning task, the cleaning robot to perform mop cleaning includes: determining a supplementary drying duration according to the elapsed drying duration of the mop, and controlling, according to the supplementary drying duration, the cleaning robot to perform supplementary mop drying.

In an example, the time information includes a duration of the cleaning robot being in the unexecutable state, and the controlling, according to time information associated with the mop cleaning task, the cleaning robot to perform mop cleaning includes:

controlling, according to the duration of the cleaning robot being in the unexecutable state, the cleaning robot to perform mop cleaning.

In an example, the time information includes a duration of the cleaning robot being in the unexecutable state and an elapsed drying duration of the mop, and the controlling, according to time information associated with the mop cleaning task, the cleaning robot to perform mop cleaning includes:

controlling, according to the duration of the cleaning robot being in the unexecutable state and the elapsed drying duration of the mop, the cleaning robot to perform mop cleaning.

In an example, the mop may include a plurality of to-be-dried mop regions, and the elapsed drying duration includes elapsed region drying durations of the to-be-dried mop regions, and the controlling, according to the duration of the cleaning robot being in the unexecutable state and the elapsed drying duration of the mop, the cleaning robot to perform mop cleaning includes: determining, according to the duration and the elapsed region drying durations, whether the cleaning robot needs to be controlled to perform mop re-washing; controlling, if the cleaning robot needs to be controlled to perform mop re-washing, the cleaning robot to perform mop washing and full mop drying; and determining a supplementary drying duration according to the elapsed region drying durations if the cleaning robot does not need to be controlled to perform mop re-washing, and controlling, according to the supplementary drying duration, the cleaning robot to perform supplementary mop drying.

The determining a supplementary drying duration according to the elapsed region drying durations includes: determining a minimum value in the elapsed region drying durations, and calculating the supplementary drying duration according to the minimum value in the elapsed region drying durations. For example, assuming that a full drying duration of each to-be-dried mop region is 1.5 hours, and a minimum value in the elapsed region drying durations is 30 minutes, a supplementary drying duration of the to-be-dried mop regions is one hour.

According to the foregoing mop cleaning method, the task status corresponding to the mop cleaning task of the cleaning robot is first determined, and when the task status changes from the unexecutable state to the executable state, the cleaning robot is triggered to automatically perform the mop cleaning step: controlling, according to the mop status of the cleaning robot, the cleaning robot to perform mop cleaning, where the mop cleaning includes at least one of mop washing and mop drying. In this way, even if the cleaning robot is in the mop cleaning task-unexecutable state due to a reason such as a do-not-disturb time period, the cleaning robot can still automatically perform mop cleaning according to the mop status of the cleaning robot without requiring a user to manually issue an instruction to control the cleaning robot to resume mop cleaning. Therefore, user convenience can be improved when the cleaning robot performs mop cleaning.

In an example, when the cleaning robot is in a preset do-not-disturb time period, the task status of the cleaning robot is the unexecutable state. Moreover, when the preset do-not-disturb time period is entered at a current time point, the cleaning robot may be controlled to be in a silent mode, and the task status of the mop cleaning task is set to the unexecutable state. In this case, it is determined that the mop cleaning task of the cleaning robot changes from the executable state to the unexecutable state. When the preset do-not-disturb time period ends, the task status of the mop cleaning task is set to the executable state. In this case, it is determined that the mop cleaning task of the cleaning robot changes from the unexecutable state to the executable state, and the cleaning robot is controlled to perform mop cleaning according to the mop status of the cleaning robot. In this way, in the preset do-not-disturb time period, the cleaning robot can be controlled to enter the silent state, to avoid mop cleaning in the preset do-not-disturb time period. In addition, after the preset do-not-disturb time period ends, how the cleaning robot specifically cleans the mop may be controlled according to the mop status, to ensure that the mop can be cleaned sufficiently. Therefore, reducing noise interference during mop cleaning by the cleaning robot and ensuring cleanliness of mop cleaning can be balanced.

In an example, when the cleaning robot is disconnected from the base station, the task status of the cleaning robot is set to the unexecutable state. In this case, it is determined that the mop cleaning task of the cleaning robot changes from the executable state to the unexecutable state. When the cleaning robot is reconnected to the base station, the task status of the mop cleaning task may be set to the executable state. In this case, it is determined that the mop cleaning task of the cleaning robot changes from the unexecutable state to the executable state, and the cleaning robot is controlled to perform mop cleaning according to the mop status of the cleaning robot. In this way, after disconnection of the cleaning robot from the base station interrupts mop cleaning, if it is determined that the cleaning robot is reconnected to the base station, the cleaning robot automatically controls, according to the mop status, the cleaning robot to resume mop cleaning, and the cleaning robot resumes mop cleaning without being manually controlled, thereby improving user convenience.

It should be noted that if the mop remains damp for a long duration, the mop is prone to developing an odor, affecting user experience.

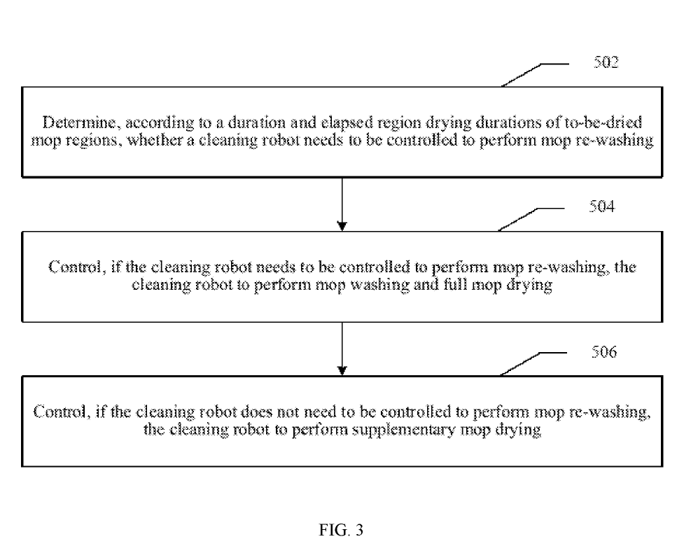

In an example, as shown in FIG. 2, the time information includes a duration of the cleaning robot being in the unexecutable state, and the controlling, according to time information associated with the mop cleaning task, the cleaning robot to perform mop cleaning includes:

Step 302: Control, if the duration is greater than a preset duration, the cleaning robot to perform mop washing and full mop drying.

Step 304: Control, if the duration is less than or equal to the preset duration, the cleaning robot to perform supplementary mop drying.

When the cleaning robot is in a preset do-not-disturb time period or the cleaning robot is disconnected from the base station, the task status of the cleaning robot is the unexecutable state. The preset do-not-disturb time period may be set by a user. For example, the preset do-not-disturb time period may be a time period when the user sleeps at night, or may be a time period when the user takes a lunch break. Therefore, a length of the preset do-not-disturb time period may be set by the user according to a need of the user.

In an example, step 302 to step 304 include: If the duration is greater than the preset duration, indicating that because the duration of the cleaning robot being in the unexecutable state is excessively long, the undried mop is prone to remaining damp for an excessively long duration and developing an odor, the cleaning robot first needs to be controlled to perform mop washing, and after the mop washing is completed, the cleaning robot is controlled to perform full drying on the mop. If the duration is equal to or less than the preset duration, indicating that because the duration of the cleaning robot being in the unexecutable state is short, the undried mop is not prone to remaining damp for an excessively long duration and developing an odor, it only needs to control, according to an elapsed drying duration of the mop, the cleaning robot to perform supplementary mop drying.

In this example, when the mop is in a drying-uncompleted state, it is determined, according to the duration of the cleaning robot being in the unexecutable state, whether the mop is prone to developing an odor after the unexecutable state is changed to the executable state. If the mop is prone to developing an odor, the cleaning robot is controlled to perform washing and full drying. If the mop is not prone to developing an odor, a supplementary drying duration of the mop is determined according to the elapsed drying duration, and the cleaning robot is controlled according to the supplementary drying duration to perform supplementary mop drying. In this way, when the mop is prone to developing an odor, the odor of the mop can be removed through mop washing and full mop drying, to ensure cleanliness of the mop. When the mop is not prone to developing an odor, supplementary mop drying is directly performed, to change the mop into a dried state as soon as possible, thereby ensuring efficiency of mop cleaning.

In an example, the time information includes a duration of the cleaning robot being in the unexecutable state and an elapsed drying duration of a mop, and the controlling, according to time information associated with the mop cleaning task, the cleaning robot to perform mop cleaning includes:

Step 402: Determine, according to the duration and the elapsed drying duration of the mop, whether mop re-washing needs to be performed.

There are usually two key factors in determining whether the mop develops an odor: one is a moisture content of the mop and the other is a duration of the mop remaining damp. The moisture content of the mop is usually related to an elapsed drying duration of the mop. A longer elapsed drying duration indicates a lower moisture content of the mop. Moreover, the duration of the mop remaining damp is usually related to the duration of the cleaning robot being in the unexecutable state. For example, the duration of the cleaning robot being in the unexecutable state may equal the duration of the mop remaining damp.

In an example, step 402 includes: predicting, according to the duration and the elapsed drying duration of the mop, a probability that the mop develops an odor; determining, if the probability that the mop develops an odor is greater than a preset probability threshold, that mop re-washing needs to be performed; and determining, if the probability that the mop develops an odor is less than or equal to the preset probability threshold, that mop re-washing does not need to be performed.

In an example, the probability that the mop develops an odor is directly proportional to the length of the preset do-not-disturb time period, and is inversely proportional to the elapsed drying duration.

In an example, step 402 includes: determining, if the duration is greater than a preset duration threshold, and the elapsed drying duration of the mop is less than a preset drying duration threshold, that mop re-washing needs to be performed; and determining, if the duration is not greater than the preset duration threshold, or the elapsed drying duration of the mop is not less than the preset drying duration threshold, that mop re-washing does not need to be performed.

Step 404: Control, if mop re-washing needs to be performed, the cleaning robot to perform mop washing and full mop drying.

Step 406: Control, if mop re-washing does not need to be performed, the cleaning robot to perform supplementary mop drying.

In an example, step 404 to step 406 include: controlling, if mop re-washing needs to be performed, the cleaning robot to perform mop washing, and controlling the cleaning robot to perform full mop drying after the mop washing is completed; and controlling, if mop re-washing does not need to be performed, according to the elapsed drying duration, the cleaning robot to perform supplementary mop drying.

In an example, the determining, according to the duration and the elapsed drying duration of the mop, whether mop re-washing needs to be performed includes:

generating a first evaluation value according to the duration and the elapsed drying duration, where the first evaluation value is used for evaluating an odor level of the mop after the task status changes from the unexecutable state to the executable state; determining, if the first evaluation value is greater than a preset evaluation value, that mop re-washing needs to be performed; and determining, if the first evaluation value is less than or equal to the preset evaluation value, that mop re-washing does not need to be performed.

The first evaluation value is used for evaluating an odor level of the mop after the preset do-not-disturb time period ends. A larger first evaluation value indicates a higher odor level of the mop after the task status changes from the unexecutable state to the executable state, and a smaller first evaluation value indicates a lower odor level of the mop after the task status changes from the unexecutable state to the executable state. A magnitude of the first evaluation value is directly proportional to the duration of the cleaning robot being in the unexecutable state, and is inversely proportional to the elapsed drying duration of the mop.

Specifically, preset weight information is obtained, and weighted aggregation is performed on a reciprocal of the duration and a reciprocal of the elapsed drying duration according to the preset weight information, to obtain the first evaluation value. A manner of the weighted aggregation may be weighted averaging, weighted summation, or the like. If the first evaluation value is greater than the preset evaluation value, indicating that after the task status changes from the unexecutable state to the executable state, the odor level of the mop is excessively high, and user experience is affected, the cleaning robot, therefore, needs to be controlled to perform mop re-washing, and after the mop re-washing is completed, the cleaning robot is then controlled to perform full drying on the mop. If the first evaluation value is less than or equal to the preset evaluation value, indicating that after the task status changes from the unexecutable state to the executable state, the odor level of the mop is low, and user experience is not affected, the cleaning robot, therefore, is controlled according to the elapsed drying duration of the mop to perform supplementary mop drying.

In this example, when the mop is in a drying-uncompleted state, the first evaluation value may be generated according to the duration of the cleaning robot being in the unexecutable state and the elapsed drying duration of the mop. The first evaluation value can be used for quantitatively analyzing an odor level of the mop after the task status changes from the unexecutable state to the executable state, and can improve accuracy of determining the odor level of the mop after the task status changes from the unexecutable state to the executable state. Therefore, when the first evaluation value is greater than the preset evaluation value, it is determined that after the task status changes from the unexecutable state to the executable state, the odor level of the mop is excessively high, and user experience is affected, so that the odor of the mop is removed through mop re-washing and full mop drying, thereby ensuring the cleanliness of the mop. When the first evaluation value is less than or equal to the preset evaluation value, it is determined that after the task status changes from the unexecutable state to the executable state, the odor level of the mop is small, and user experience is not affected, so that supplementary mop drying is directly performed, to change the mop to a dried state as soon as possible, thereby ensuring the efficiency of mop cleaning.

It should be noted that when the duration of the cleaning robot being in the unexecutable state is long, if drying is performed for only a short time or is not performed before the task status of the cleaning robot changes to the unexecutable state, the mop inevitably develops an odor after the task status of the cleaning robot changes from the unexecutable state to the executable state, and the mop needs to be re-washed and fully dried. In this case, a cleaning process of the cleaning robot before the task status changes to the unexecutable state is completely an ineffective cleaning process, resulting in a waste of power resources.

In an example, the mop cleaning method includes: controlling, if an interval duration between a current time point and a start time point of the cleaning robot being in the unexecutable state is greater than a preset interval duration, the cleaning robot to perform mop cleaning; and prohibiting, if the interval duration is less than or equal to the preset interval duration, the cleaning robot from performing mop cleaning.

When the cleaning robot is in the preset do-not-disturb time period, the task status of the cleaning robot is the unexecutable state, and when the cleaning robot is not in the preset do-not-disturb time period, the task status of the cleaning robot is the executable state. Because the preset do-not-disturb time period is set in advance, a start time point of the cleaning robot being in the unexecutable state can be known in advance.

Specifically, before a mop cleaning instruction is responded to, a current time point and a start time point at which the cleaning robot is to be in the unexecutable state are obtained, and a time interval between the current time point and the start time point is calculated, to obtain an interval duration. If the interval duration is greater than a preset interval duration, the cleaning robot is controlled to perform mop cleaning. If the interval duration is less than or equal to the preset interval duration, the cleaning robot is prohibited from performing mop cleaning until the preset do-not-disturb time period ends.

In this example, before responding to a mop cleaning instruction, the cleaning robot first detects a time interval between a current time point and a start time point of the cleaning robot being in the unexecutable state. If the time interval is greater than a preset time interval, indicating that if mop cleaning is started at this time, there is a large probability that the mop does not develop an odor after the task status changes from the unexecutable state to the executable state, the cleaning robot, therefore, is directly controlled to perform mop cleaning, to ensure that the mop can be cleaned as soon as possible. If the time interval is less than or equal to the preset time interval, indicating that if mop cleaning is started at this time, there is a large probability that the mop develops an odor after the task status changes from the unexecutable state to the executable state, therefore, it is prohibited to control the cleaning robot to perform mop cleaning, to reduce ineffective mop cleaning processes of the cleaning robot, so that the waste of power resources can be reduced.

It should be noted that the mop may be classified into an ordinary mop, a roller mop, or a flat rotating mop. For the ordinary mop, the mop is usually dried as a whole, and the mop is in a static state during drying. For the roller mop or the flat rotating mop, when such a mop is dried, because an angle of an air outlet used for mop drying is limited, during mop drying, the mop needs to be rotated for gradually drying mop regions, that is, a mop region facing the air outlet is first dried for a period of time, and then the mop is rotated, so that another mop region of the mop faces the air outlet for drying, until all to-be-dried mop regions of the mop are dried.

In an example, as shown in FIG. 3, a mop of the cleaning robot includes a plurality of to-be-dried mop regions, and the time information includes a duration of the cleaning robot being in the unexecutable state and elapsed region drying durations of the to-be-dried mop regions. The controlling, according to time information associated with the mop cleaning task, the cleaning robot to perform mop cleaning includes:

Step 502: Determine, according to the duration and the elapsed region drying durations of the to-be-dried mop regions, whether mop re-washing needs to be performed.

The elapsed region drying duration is an elapsed drying duration of a to-be-dried mop region. The mop may be a roller mop or a flat rotating mop. During drying, such a mop needs to be rotated. The elapsed region drying durations of the to-be-dried mop regions of the mop are different, resulting in different moisture contents of the to-be-dried mop regions, which, in turn, affect a final determining result indicating whether the mop has an odor after the task status changes from the unexecutable state to the executable state. For example, because different to-be-dried mop regions of the mop need to be rotated to face the air outlet for drying, there is a case in which a to-be-dried mop region A has a longer elapsed region drying duration, but a to-be-dried mop region B has a shorter elapsed region drying duration. In this case, the to-be-dried mop region A has a lower moisture content and is not prone to developing an odor after the task status changes from the unexecutable state to the executable state, but the to-be-dried mop region B has a higher moisture content and is prone to developing an odor after the task status changes from the unexecutable state to the executable state.

In an example, step 502 includes: selecting a drying duration with a minimum value from the elapsed region drying durations as a target drying duration; predicting, according to the target drying duration and the duration of the cleaning robot being in the unexecutable state, a probability that mop develops an odor; determining, if the probability that the mop develops an odor is greater than a preset probability threshold, that mop re-washing needs to be performed on the mop; and determining, if the probability that the mop develops an odor is less than or equal to the preset probability threshold, mop re-washing does not need to be performed on the mop.

In an example, step 502 includes: performing weighted aggregation on the elapsed region drying durations according to weighted weights of the to-be-dried mop regions, to obtain a target drying duration; predicting, according to the target drying duration and the duration of the cleaning robot being in the unexecutable state, a probability that mop develops an odor; determining, if the probability that the mop develops an odor is greater than a preset probability threshold, that mop re-washing needs to be performed on the mop; and determining, if the probability that the mop develops an odor is less than or equal to the preset probability threshold, mop re-washing does not need to be performed on the mop.

In an example, the probability that the mop develops an odor is inversely proportional to the target drying duration, and is directly proportional to the length of the preset do-not-disturb time period.

In an example, step 502 includes: generating a target drying duration according to the elapsed region drying durations, where a minimum elapsed region drying duration may be selected as the target drying duration or the elapsed region drying durations may be aggregated in a weighted manner into the target drying duration; determining, if the duration is greater than a preset duration threshold, and the target drying duration is less than a preset drying duration threshold, that mop re-washing needs to be performed; and determining, if the duration is not greater than the preset duration threshold, or the target drying duration is not less than the preset drying duration threshold, that mop re-washing does not need to be performed.

Step 504: Control, if mop re-washing needs to be performed, the cleaning robot to perform mop washing and full mop drying.

Step 506: Control, if mop re-washing does not need to be performed, the cleaning robot to perform supplementary mop drying.

In an example, step 504 to step 506 include: controlling, if mop re-washing needs to be performed, the cleaning robot to perform mop re-washing, and controlling the cleaning robot to perform full mop drying after the mop re-washing is completed; and controlling, if mop re-washing does not need to be performed, according to the elapsed region drying durations, the cleaning robot to perform supplementary mop drying.

In an example, the determining, according to the duration and the elapsed region drying durations of the to-be-dried mop regions, whether mop re-washing needs to be performed includes: respectively generating, according to the duration and the elapsed region drying durations, second evaluation values corresponding to the to-be-dried mop regions, where the second evaluation value is used for evaluating an odor level of the to-be-dried mop region after the task status changes from the unexecutable state to the executable state; determining, if a maximum value in the second evaluation values is greater than a preset evaluation value, that mop re-washing needs to be performed; and determining, if the maximum value in the second evaluation values is less than or equal to the preset evaluation value, that the mop re-washing does not need to be performed.

The second evaluation value is used for evaluating an odor level of a to-be-dried mop region after the task status changes from the unexecutable state to the executable state. A larger second evaluation value indicates a higher odor level of the to-be-dried mop region after the task status changes from the unexecutable state to the executable state, and a smaller second evaluation value indicates a lower odor level of the to-be-dried mop region after the task status changes from the unexecutable state to the executable state. A magnitude of the second evaluation value is directly proportional to the duration of the cleaning robot being in the unexecutable state, and is inversely proportional to the elapsed region drying duration.

Specifically, preset weight information is obtained, and weighted aggregation is performed on an elapsed region drying duration of each to-be-dried mop region and the duration according to the preset weight information, to obtain the second evaluation values of the to-be-dried mop regions. A manner of the weighted aggregation may be weighted averaging, weighted summation, or the like. If a maximum value in the second evaluation values is greater than the preset evaluation value, indicating that after the task status changes from the unexecutable state to the executable state, the odor level of the mop is excessively high, and user experience is affected, mop washing needs to be performed first, and after the mop washing is completed, the cleaning robot is then controlled to perform full drying on the mop. If the maximum value in the second evaluation values is less than or equal to the preset evaluation value, indicating that after the task status changes from the unexecutable state to the executable state, the odor level of the mop is low, and user experience is not affected, the cleaning robot, therefore, is controlled according to the elapsed drying duration of the mop to perform supplementary mop drying on the mop.

In this example, when the mop is in a not-being-dried state, the second evaluation values of the to-be-dried mop regions may be generated according to the duration of the cleaning robot being in the unexecutable state and the elapsed drying durations of the to-be-dried mop regions of the mop. The second evaluation values can be used for quantitatively analyzing an odor level of the mop after the task status changes from the unexecutable state to the executable state. Considering that because the mop needs to be rotated for drying, the mop regions are dried unevenly, which affects determining whether the mop develops an odor after the preset do-not-disturb time period ends, the accuracy of determining the odor level of the mop after the task status changes from the unexecutable state to the executable state can be improved. Therefore, when the maximum value in the second evaluation values is greater than the preset evaluation value, it is determined that after the task status changes from the unexecutable state to the executable state, the odor level of the mop is excessively high, and user experience is affected, so that the odor of the mop is removed through mop re-washing and full mop drying, thereby ensuring the cleanliness of the mop. When the maximum value in the second evaluation values is less than or equal to the preset evaluation value, it is determined that after the task status changes from the unexecutable state to the executable state, the odor level of the mop is small, and user experience is not affected, so that supplementary mop drying is directly performed, to change the mop to a dried state as soon as possible, thereby ensuring the efficiency of mop cleaning.

In an example, before the determining, according to the duration and the elapsed region drying durations of the to-be-dried mop regions, whether mop re-washing needs to be performed, the mop cleaning method further includes:

obtaining a number of completed rotations of the mop in a drying process; and determining the elapsed region drying durations of the to-be-dried mop regions according to the number of completed rotations and a total elapsed drying duration of the mop.

For a mop with a plurality of to-be-dried mop regions, when mop drying is performed on the mop, the cleaning robot usually controls the mop to rotate once every time period, to cause a new to-be-dried mop region of the mop to face the air outlet for drying.

Specifically, a number of completed rotations of the mop in a drying process is obtained. The elapsed region drying durations of the to-be-dried mop regions are respectively calculated according to a preset rotation angle, the number of completed rotations, and a total elapsed drying duration of the mop.

In an example, assuming that the preset rotation angle is 180 degrees, indicating that the mop includes two to-be-dried mop regions, and if the number of completed rotations is one, and the total elapsed drying duration is 40 minutes, it indicates that an elapsed drying duration of one to-be-dried mop region of the mop is 30 minutes, and an elapsed drying duration of the other to-be-dried mop region is 10 minutes.

In this example, by obtaining a number of completed rotations of the mop in a drying process, elapsed region drying durations of the to-be-dried mop regions in the mop can be accurately calculated according to the number of completed rotations and the total elapsed drying duration of the mop, which lays a foundation for determining, according to the duration and the elapsed region drying durations of the to-be-dried mop regions, whether mop re-washing needs to be performed.

In an example, a task status corresponding to a mop cleaning task of the cleaning robot is determined. If the task status changes from the unexecutable state to the executable state, when the mop status is a to-be-washed state or a washing-uncompleted state, the cleaning robot is controlled to perform mop washing, and the cleaning robot is controlled to perform full mop drying after the washing is completed.

Further, if the mop status is a washed but drying-uncompleted state, a duration of the cleaning robot being in the unexecutable state is obtained. If the duration is greater than a preset duration, this indicates that because the duration of the cleaning robot being in the unexecutable state is excessively long, the undried mop is prone to remaining damp for an excessively long duration and developing an odor, mop re-washing needs to be performed first, and after the mop re-washing is completed, the cleaning robot is then controlled to perform full drying on the mop. If the duration is equal to or less than the preset duration, indicating that because the duration of the cleaning robot being in the unexecutable state is short, the undried mop is not prone to remaining damp for an excessively long duration and developing an odor, it only needs to control, according to an elapsed drying duration of the mop, the cleaning robot to perform supplementary mop drying. In this way, when the mop is prone to developing an odor, the odor of the mop can be removed through mop washing and full mop drying, to ensure cleanliness of the mop. When the mop is not prone to developing an odor, supplementary mop drying is directly performed, to change the mop into a dried state as soon as possible, thereby ensuring efficiency of mop cleaning.

In addition, in this example, during mop cleaning, even if the cleaning robot is in the mop cleaning task-unexecutable state due to a reason such as a do-not-disturb time period, the cleaning robot can still automatically perform mop cleaning according to the mop status of the cleaning robot without requiring a user to manually issue an instruction to control the cleaning robot to resume mop cleaning. Therefore, user convenience can be improved when the cleaning robot performs mop cleaning.

Although the steps in the flowcharts involved in the foregoing examples are displayed sequentially according to instructions of arrows, these steps are not necessarily performed sequentially according to a sequence instructed by the arrows. Unless otherwise clearly specified in this specification, the steps are performed without any strict sequence limit, and may be performed in other sequences. In addition, at least some of the steps in the flowcharts involved in the foregoing examples may include a plurality of steps or a plurality of stages. These steps or stages are not necessarily performed and completed at the same moment, and may be performed at different moments. Besides, the steps or stages may not be necessarily performed sequentially, and may be performed in turn or alternately with other steps or at least a part of steps or stages of other steps.

Based on the same inventive idea, the examples of this application further provide a mop cleaning apparatus, configured to implement the foregoing involved mop cleaning method. The solution to the problem provided by the apparatus is similar to the solution described in the foregoing method. Therefore, for specific limitations in one or more examples of the mop cleaning apparatus provided below, reference may be made to the limitations on the mop cleaning method above. Details are not described herein again.

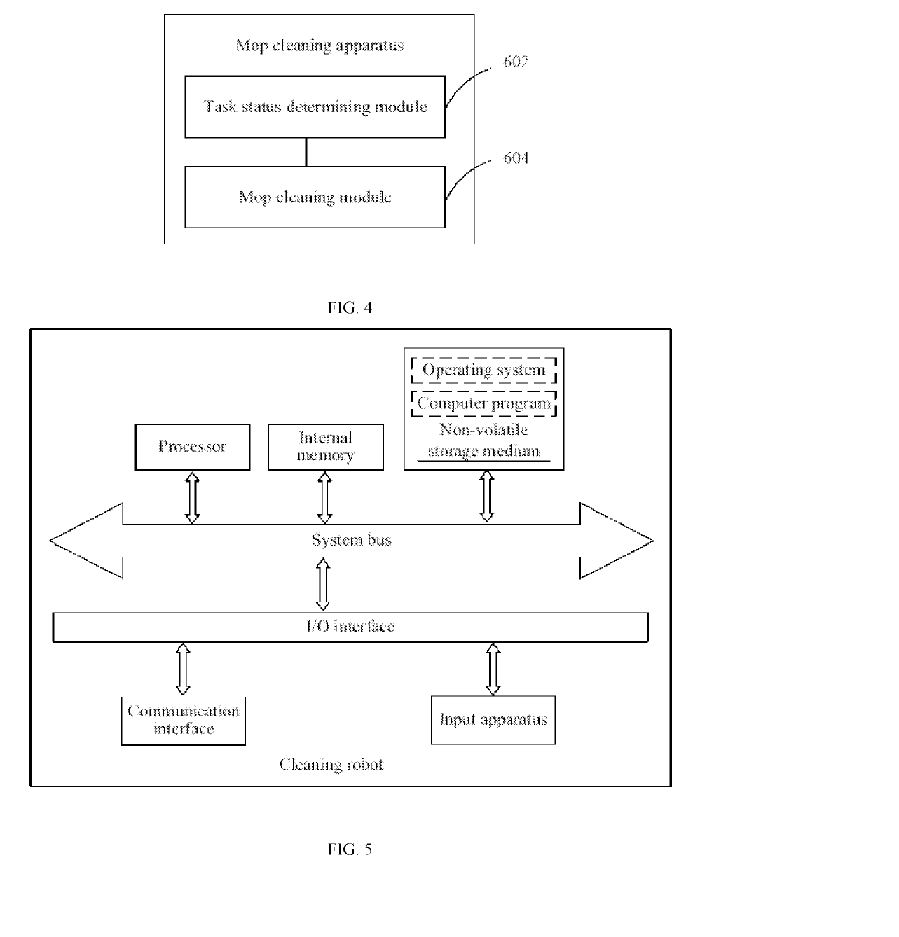

In an example, as shown in FIG. 4, a mop cleaning apparatus is provided, including a task status determining module 602 and a mop cleaning module 604.

The task status determining module is configured to determine a task status corresponding to a mop cleaning task of the cleaning robot.

The mop cleaning module is configured to trigger a mop cleaning step if the task status changes from an unexecutable state to an executable state: controlling, according to a mop status of the cleaning robot, the cleaning robot to perform mop cleaning, where the mop cleaning includes at least one of mop washing and mop drying.

In one of the examples, the mop cleaning module is further configured to:

control, if the mop status is a to-be-washed state or a washing-uncompleted state, the cleaning robot to perform mop washing and full mop drying; and control, if the mop status is a washed but drying-uncompleted state, according to time information associated with the mop cleaning task, the cleaning robot to perform mop cleaning.

In one of the examples, the time information includes a duration of the cleaning robot being in the unexecutable state. The mop cleaning module is configured to:

control, if the duration is greater than a preset duration, the cleaning robot to perform mop washing and full mop drying; and control, if the duration is less than or equal to the preset duration, the cleaning robot to perform supplementary mop drying.

In one of the examples, the time information includes a duration of the cleaning robot being in the unexecutable state and an elapsed drying duration of a mop. The mop cleaning module is configured to:

determine, according to the duration and the elapsed drying duration of the mop, whether mop re-washing needs to be performed; control, if mop re-washing needs to be performed, the cleaning robot to perform mop washing and full mop drying; and control, if mop re-washing does not need to be performed, the cleaning robot to perform supplementary mop drying.

In one of the examples, the mop cleaning module is configured to:

generate a first evaluation value according to the duration and the elapsed drying duration, where the first evaluation value is used for evaluating an odor level of the mop after the task status changes from the unexecutable state to the executable state; determine, if the first evaluation value is greater than a preset evaluation value, that the cleaning robot needs to be controlled to perform mop re-washing; and determine, if the first evaluation value is less than or equal to the preset evaluation value, that the cleaning robot does not need to be controlled to perform mop re-washing.

In one of the examples, the mop cleaning apparatus further includes:

a mop cleaning switch module, configured to control, if an interval duration between a current time point and a start time point of the cleaning robot being in the unexecutable state is greater than a preset interval duration, the cleaning robot to perform mop cleaning; and prohibit, if the interval duration is less than or equal to the preset interval duration, the cleaning robot from performing mop cleaning.

In one of the examples, a mop of the cleaning robot includes a plurality of to-be-dried mop regions, and the time information includes a duration of the cleaning robot being in the unexecutable state and elapsed region drying durations of the to-be-dried mop regions. The mop cleaning module is further configured to: determine, according to the duration and the elapsed region drying durations of the to-be-dried mop regions, whether the cleaning robot needs to be controlled to perform mop re-washing; control, if mop re-washing needs to be performed, the cleaning robot to perform mop washing and full mop drying; and control, if mop re-washing does not need to be performed, the cleaning robot to perform supplementary mop drying.

In one of the examples, the mop cleaning module is further configured to: respectively generate, according to the duration and the elapsed region drying durations, second evaluation values corresponding to the to-be-dried mop regions, where the second evaluation value is used for evaluating an odor level of the to-be-dried mop region after the task status changes from the unexecutable state to the executable state; determine, if a maximum value in the second evaluation values is greater than a preset evaluation value, that the cleaning robot needs to be controlled to perform mop re-washing; and determine, if the maximum value in the second evaluation values is less than or equal to the preset evaluation value, that the cleaning robot does not need to be controlled to perform mop re-washing.

In one of the examples, the mop cleaning apparatus further includes: an elapsed region drying duration determining module, configured to obtain a number of completed rotations of the mop in a drying process; and determine the elapsed region drying durations of the to-be-dried mop regions according to the number of completed rotations and a total elapsed drying duration of the mop.

In one of the examples, the mop cleaning apparatus further includes: a first task status determining module, configured to set the task status of the mop cleaning task to the unexecutable state if a current time point falls within a preset do-not-disturb time period; and set the task status of the mop cleaning task to the executable state if the current time point does not fall within the preset do-not-disturb time period.

In one of the examples, the mop cleaning apparatus further includes: a second task status determining module, configured to set the task status of the mop cleaning task to the unexecutable state if the cleaning robot is disconnected from a base station; and set the task status of the mop cleaning task to the executable state if the cleaning robot is connected to the base station.

The modules in the foregoing mop cleaning apparatus may be implemented entirely or partially by software, hardware, or a combination thereof. The foregoing modules may be built in or independent of a processor of the cleaning robot in a hardware form, or may be stored in a memory of the cleaning robot in a software form, so that the processor invokes and performs operations corresponding to the foregoing modules.

In an example, a cleaning system is provided, including a cleaning robot and a base station. The cleaning robot includes a body and a mop arranged on the body. The base station includes a washing sink configured for washing the mop and a drying module configured to dry the mop. A diagram of an internal structure of the cleaning robot may be shown in FIG. 5. The cleaning robot includes a processor, a memory, a communication interface, and an input apparatus that are connected by a system bus. The processor of the cleaning robot is configured to provide computing and control capabilities. The memory of the cleaning robot includes a non-transitory non-volatile storage medium and an internal memory. The non-volatile storage medium has an operating system and a computer program stored therein. The internal memory provides an environment for running of the operating system and the computer program in the non-volatile storage medium. The communication interface of the cleaning robot is used for wired or wireless communication with an external terminal. The wireless manner may be implemented through Wi-Fi, a mobile cellular network, near field communication (NFC), or other technologies. The computer program is executed by the processor to implement a mop cleaning method.

A person skilled in the art may understand that, the structure shown in FIG. 5 is only a block diagram of a part of a structure related to a solution of this application and does not limit the cleaning robot to which the solution of this application is applied. Specifically, the cleaning robot may include more or fewer components than those in the drawings, or include a combination of some components, or include different component layouts.

In an example, a cleaning system is further provided, including a cleaning robot and a base station docked to the cleaning robot. The cleaning robot includes a body and a mop arranged on the body. The base station includes a washing sink configured for washing the mop and a drying module configured to dry the mop. After completing a cleaning task including a mopping task, the cleaning robot returns to the base station for charging and mop cleaning. When the cleaning robot is offline, loses communication with the base station, or enters a do-not-disturb mode set by a user, and so on, mop cleaning cannot be performed. That is, in this case, the cleaning robot is in a mop cleaning task-unexecutable state. When the cleaning robot is online again, establishes a connection to the base station, or ends the do-not-disturb mode, and so on, the cleaning robot automatically performs mop cleaning based on the foregoing method. In this case, the cleaning robot is in a mop cleaning task-executable state.

The cleaning robot includes a memory and a processor. The memory has a computer program stored therein. The processor, when executing the computer program, implements the steps in the foregoing method examples.

In an example, a computer-readable storage medium is provided, having a computer program stored therein. When executed by the processor, the computer program causes the processor to perform the steps in the foregoing method examples.

In an example, a computer program product is provided, including a computer program. The computer program, when executed by the processor, implements the steps in the foregoing method examples.

A person of ordinary skill in the art may understand that all or some of procedures of the method in the foregoing examples may be implemented by a computer program instructing relevant hardware. The computer program may be stored in a non-volatile computer-readable storage medium. When the computer program is executed, the procedures of the foregoing method examples may be implemented. Any reference to a memory, a database, or another medium used in the examples provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric m random access memory (FRAM), a phase change memory (PCM), a graphene memory, and the like. The volatile memory may include a random access memory (RAM), an external cache, or the like. For the purpose of description instead of limitation, the RAM is available in a plurality of forms, such as a static RAM (SRAM) or a dynamic RAM (DRAM). The database involved in the examples provided in this application may include at least one of a relational database and a non-relational database. The non-relational database may include a blockchain-based distributed database and the like, but is not limited thereto. The processor involved in the examples provided in this application may be a general-purpose processor, a central processing unit, a graphics processing unit, a digital signal processor, a programmable logic device, a data processing logic device based on quantum computing, or the like, but is not limited thereto.

The technical features in the foregoing examples may be randomly combined. For concise description, not all possible combinations of the technical features in the examples are described. However, provided that combinations of the technical features do not conflict with each other, the combinations of the technical features are considered as falling within the scope described in this specification.

The foregoing examples merely express several implementations of this application. The descriptions thereof are relatively specific and detailed, but should not be understood as limitations to the scope of this application. A person of ordinary skill in the art may make various changes and improvements without departing from the ideas of the present disclosure, which shall all fall within the protection scope of the present disclosure. Therefore, the protection scope of the present disclosure is subject to the protection scope of the appended claims.

What is claimed is:

1. A mop cleaning method of a cleaning robot, comprising:
determining a task status of a mop cleaning task of the cleaning robot;
determining that the task status changes from an unexecutable state to an executable state; and
in response to determining that the task status changes from the unexecutable state to the executable state, controlling, based on a mop status of the cleaning robot, the cleaning robot to perform mop cleaning, wherein the mop cleaning comprises at least one of mop washing or mop drying.

2. The method according to claim 1, wherein the controlling comprises:
based on the mop status being a to-be-washed state or a washing-uncompleted state, controlling the cleaning robot to perform mop washing and full mop drying; and
based on the mop status being a washed but drying-uncompleted state, controlling, according to time information associated with the mop cleaning task, the cleaning robot to perform mop cleaning.

3. The method according to claim 2, wherein the time information comprises a duration of the cleaning robot being in the unexecutable state, and the controlling, according to time information associated with the mop cleaning task, the cleaning robot to perform mop cleaning comprises:
based on the duration being greater than a preset duration, controlling the cleaning robot to perform mop washing and full mop drying; and
based on the duration being less than or equal to the preset duration, controlling the cleaning robot to perform supplementary mop drying.

4. The method according to claim 2, wherein the time information comprises a duration of the cleaning robot being in the unexecutable state and an elapsed drying duration of a mop, and the controlling, according to time information associated with the mop cleaning task, the cleaning robot to perform mop cleaning comprises:
determining, according to the duration and the elapsed drying duration of the mop, whether mop re-washing needs to be performed;
in response to determining that mop re-washing needs to be performed, controlling the cleaning robot to perform mop washing and full mop drying; and
in response to determining that mop re-washing does not need to be performed, controlling the cleaning robot to perform supplementary mop drying.

5. The method according to claim 4, wherein the determining, according to the duration and the elapsed drying duration of the mop, whether mop re-washing needs to be performed, comprises:
generating a first evaluation value according to the duration and the elapsed drying duration, wherein the first evaluation value is used for evaluating an odor level of the mop after the task status changes from the unexecutable state to the executable state;
based on determining that the first evaluation value is greater than a preset evaluation value, determining that mop re-washing needs to be performed; and
based on determining that the first evaluation value is less than or equal to the preset evaluation value, determining that mop re-washing does not need to be performed.

6. The method according to claim 1, further comprising:
controlling, based on an interval duration between a current time point and a start time point of the cleaning robot being in the unexecutable state being greater than a preset interval duration, the cleaning robot to perform mop cleaning; and
prohibiting, based on the interval duration being less than or equal to the preset interval duration, the cleaning robot from performing mop cleaning.

7. The method according to claim 2, wherein a mop of the cleaning robot comprises a plurality of to-be-dried mop regions, the time information comprises a duration of the cleaning robot being in the unexecutable state and elapsed region drying durations of the to-be-dried mop regions, and the controlling, according to time information associated with the mop cleaning task, the cleaning robot to perform mop cleaning comprises:
determining, according to the duration and the elapsed region drying durations of the to-be-dried mop regions, whether mop re-washing needs to be performed; and
in response to determining that mop re-washing needs to be performed, controlling the cleaning robot to perform mop washing and full mop drying; and
in response to determining that mop re-washing does not need to be performed controlling the cleaning robot to perform supplementary mop drying.

8. The method according to claim 7, wherein the determining, according to the duration and the elapsed region drying durations of the to-be-dried mop regions, whether mop re-washing needs to be performed comprises:
respectively generating, according to the duration and the elapsed region drying durations, second evaluation values corresponding to the to-be-dried mop regions, wherein the second evaluation values are used for evaluating an odor level of the to-be-dried mop regions after the task status changes from the unexecutable state to the executable state;
determining, based on a maximum value in the second evaluation values being greater than a preset evaluation value, that mop re-washing needs to be performed; and
determining, based on the maximum value in the second evaluation values being less than or equal to the preset evaluation value, that the mop re-washing does not need to be performed.

9. The method according to claim 7, wherein before the determining, according to the duration and the elapsed region drying durations of the to-be-dried mop regions, whether mop re-washing needs to be performed, the method further comprises:
obtaining a number of completed rotations of the mop in a drying process; and
determining the elapsed region drying durations of the to-be-dried mop regions according to the number of completed rotations and a total elapsed drying duration of the mop.

10. The method according to claim 1, further comprising:
setting the task status of the mop cleaning task to the unexecutable state based on a current time point falling within a preset do-not-disturb time period; and
setting the task status of the mop cleaning task to the executable state based on the current time point not falling within the preset do-not-disturb time period.

11. The method according to claim 1, further comprising:
setting the task status of the mop cleaning task to the unexecutable state based on the cleaning robot being disconnected from a base station; and
setting the task status of the mop cleaning task to the executable state based on the cleaning robot being connected to the base station.

12. A cleaning system, comprising a cleaning robot and a base station, wherein:
the cleaning robot comprises a body and a mop arranged on the body;
the base station comprises a washing sink configured for washing the mop and a drying module configured to dry the mop; and
the cleaning robot is configured to:
determine a task status of a mop cleaning task of the cleaning robot;
determine that the task status changes from an unexecutable state to an executable state; and
in response to determining that the task status changes from the unexecutable state to the executable state, perform, based on a mop status of the cleaning robot, mop cleaning, wherein the mop cleaning comprises at least one of mop washing or mop drying.

13. The cleaning system according to claim 12, wherein the cleaning robot is further configured to:
based on a duration of the cleaning robot being in the unexecutable state being greater than a preset duration, perform mop washing and full mop drying; and
based on the duration being less than or equal to the preset duration, perform supplementary mop drying.

14. The cleaning system according to claim 12, wherein the cleaning robot is further configured to:
determine, according to a duration of the cleaning robot being in the unexecutable state and an elapsed drying duration of the mop, whether mop re-washing needs to be performed;
in response to determining that mop re-washing needs to be performed, perform mop washing and full mop drying; and
in response to determining that mop re-washing does not need to be performed, perform supplementary mop drying.

15. The cleaning system according to claim 12, wherein the cleaning robot is further configured to:
perform, based on an interval duration between a current time point and a start time point of the cleaning robot being in the unexecutable state being greater than a preset interval duration, mop cleaning; and
prohibit, based on the interval duration being less than or equal to the preset interval duration, the cleaning robot from performing mop cleaning.

16. The cleaning system according to claim 12, wherein the cleaning robot is further configured to:
determine, according to a duration of the cleaning robot being in the unexecutable state and an elapsed region drying durations of to-be-dried mop regions, whether mop re-washing needs to be performed;
in response to determining that mop re-washing needs to be performed, perform mop washing and full mop drying; and
in response to determining that mop re-washing does not need to be performed, perform supplementary mop drying.

17. The cleaning system according to claim 12, wherein the cleaning robot is further configured to:
set the task status of the mop cleaning task to the unexecutable state based on the cleaning robot being disconnected from the base station; and
set the task status of the mop cleaning task to the executable state based on the cleaning robot being connected to the base station.

18. The cleaning system according to claim 12, wherein the cleaning robot is configured to perform mop cleaning by:
based on the mop status being a to-be-washed state or a washing-uncompleted state, performing mop washing and full mop drying; and
based on the mop status being a washed but drying-uncompleted state, performing, according to time information associated with the mop cleaning task, mop cleaning.

19. The cleaning system according to claim 12, wherein the cleaning robot is further configured to:
set the task status of the mop cleaning task to the unexecutable state based on a current time point falling within a preset do-not-disturb time period; and
set the task status of the mop cleaning task to the executable state based on the current time point not falling within the preset do-not-disturb time period.

20. A non-transitory computer-readable storage medium storing instructions, when executed, cause:
determining a task status of a mop cleaning task of a cleaning robot;
determining that the task status changes from an unexecutable state to an executable state; and
in response to determining that the task status changes from the unexecutable state to the executable state, controlling, based on a mop status of the cleaning robot, the cleaning robot to perform mop cleaning, wherein the mop cleaning comprises at least one of mop washing or mop drying.
